(19) United States
(12) Patent Application Publication
(10) Pub. No.: US 2011/0193681 A1
(43) Pub. Date: Aug. 11, 2011

(54) Office Notification Systems and Methods

(76) Inventor: Richard K. Rood, Lakeway, TX (US)

(21) Appl. No.: 12/902,780

(22) Filed: Oct. 12, 2010

Related U.S. Application Data
(60) Provisional application No. 61/250,654, filed on Oct. 12, 2009.

(51) Int. Cl. G08B 5/22

(52) U.S. Cl. 340/6.1

(57) ABSTRACT

A system for use in multi-rooms of an office space, provides wireless or other communicative connection among paired devices for each separate room and a central device. The system includes a central control device, an inner panel device communicatively connected to the central control device, and an outer panel device communicatively connected to the inner panel device. The control center device includes illuminated notifiers and control center buttons, the inner panel device includes inner panel buttons and a video display, and the outer panel device includes outer panel buttons and a static display. Activation of buttons of the respective devices changes state of the illuminated notifiers of the control center device. Activation of buttons of the control center device changes state of buttons of the inner panel device and the outer panel device, activation of buttons of the inner panel device changes state of buttons of the outer panel device and the control center device, and activation of buttons of the outer panel device changes state of the buttons of the inner panel device and the control center device. Audio and video content is displayed as multimedia on the video display and in static format on the static display.

### TECHNICAL FIELD

The present disclosure generally relates generally to multi-room office status notifiers and more particularly relates to wireless communicative notification devices in a coordinated system and method for offices and other businesses operating in multiple rooms or worksites in a single location with various scheduling requirements for the rooms among single or multiple providers, and including digital and static media content delivery for the rooms.

### BACKGROUND

Offices of multiple rooms or worksites, for example, doctor offices of a medical group, often receive much visitor traffic. In some instances, the multiple rooms or worksites are occupied or shared by or among several providers. In the case of doctors, and in particular, groups of doctors sharing offices, a number of patients typically visit in any given day or period. Conventional notification schemes employed to alert to room occupancy, such as for patient examination rooms, in such multi-room office arrangements include colored cards displayed on doors to the rooms, patient file shelfs adjacent the doors, and other flags. When the door to a room is closed, such flags are necessary to alert those outside the room to occupancy or other in-use conditions. Confusion can occur about use condition if flags are not properly displayed or employed as indicators.

Even when flags are proper, certain interruptions to those in the room may be desired or necessary. Those in the room may not easily communicate availability or lack of availability of the room occupants to outside the room. Moreover, those in the room awaiting another person, such as a patient waiting for the doctor to arrive at the room, often spend significant time waiting. During wait time, there is often little within the room to bide the wait.

It would, therefore, be desirable to provide new and improved room status notifiers for offices. It would also be desirable for such notifiers to offer more streamlined and accurate operations in practice. Other advantages, for example, providing digital content in the nature of educational, entertainment, advertising and/or other purposes to room occupants during wait times or other periods, would be desired by advertisers and those wishing to communicate information to the occupants. Occupants would desire such information during the time of occupancy, particularly, during wait periods and the like.

### SUMMARY

An embodiment of the invention is a system for use in multi-rooms of an office or other multi-roomed space, providing wireless or other communicative connection among paired devices for each separate room and a central device. The system includes a central control device, an inner panel device communicatively connected to the central control device, and an outer panel device communicatively connected to the inner panel device. In certain embodiments, the outer panel device can be communicatively connected with the control center device, either directly or through other devices, such as via the inner panel device. The control center device includes illuminated notifiers and control center buttons. The illuminated notifiers identify a state of each of the inner panel device and the outer panel device, as communicated between the inner panel device and the control center device. The control center buttons, when selectively activated, can change a state of the inner panel device. The inner panel device includes a video display and inner panel buttons. The inner panel buttons flag and show a state of the inner panel device, according to states of the outer panel device and the control center device, as communicated between the inner panel device and the control center device and as communicated between the outer panel device and the inner panel device. The outer panel device includes a static display and outer panel buttons. The outer panel buttons flag and show a state of the inner panel device, according to states of the inner panel device, as communicated between the inner panel device and the outer panel device. A change of state at the outer panel device, via selective activation of an outer panel button, is communicated to the inner panel device and on to the control panel device. States at the inner panel device and the control panel device are changed accordingly. A change of state at the inner panel device, via selective activation of an inner panel button, is communicated to the outer panel device and the to the control panel device. States at the outer panel device and the control panel device are changed accordingly. At the control center device, select activation of a control center button for the particular inner panel device effects a change to state of the inner panel device and the outer panel device. In certain embodiments, the inner panel device and/or the control center device can include audible communication features for verbal messages between these devices, which features can be blocked or allowed via operation of the inner panel buttons at the inner panel device. Pluralities of pairs of inner panel device and corresponding outer panel device operate with a same control center device. Video and static displays of devices allow image, information and multimedia display on the respective devices.

In certain alternatives, the devices, or certain of them, are programmable and expandable to vary operation of the panels and control center and respective buttons, to alter display illumination by the buttons, to change responsive characteristics among the panels and control center, and for other alternative features and functions

### BRIEF DESCRIPTION OF THE DRAWINGS

The present invention is illustrated by way of example and not limitation in the accompanying figures, in which like references indicate similar elements, and in which:

FIG. 1 illustrates a system for office status notification, according to certain embodiments of the invention;

FIG. 2 illustrates a control center device of the system of FIG. 1, according to certain embodiments of the invention;

FIG. 3 illustrates an inner panel device of the system of FIG. 1, according to certain embodiments of the invention;

FIG. 4 illustrates an outer panel device of the system of FIG. 1, according to certain embodiments of the invention;

FIG. 5 illustrates a system for office status notification including a plurality of pairs of inner panel device and corresponding outer panel device operating with a same control center device, according to certain embodiments of the invention;

FIG. 6 illustrates a method of office status notification, according to certain embodiments of the invention;

FIG. 7 illustrates a perspective view of an embodiment of a control center device, such as that of FIG. 2, according to certain embodiments of the invention;

FIG. 8 illustrates a perspective view of an embodiment of an inner panel device, such as that of FIG. 3, according to certain embodiments of the invention;

FIG. 9 illustrates a perspective view of an embodiment of an outer panel device, such as that of FIG. 4, according to certain embodiments of the invention;

FIG. 10 illustrates an embodiment of a use and location of a control center device, such as that of FIGS. 2 and 7, according to certain embodiments of the invention;

FIG. 11 illustrates an embodiment of a use and location of an inner panel device, such as that of FIGS. 3 and 8, according to certain embodiments of the invention;

FIG. 12 illustrates an embodiment of a use and location of an outer panel device, such as that of FIGS. 4 and 8, according to certain embodiments of the invention;

FIG. 13 illustrates an embodiment of a portable control panel, a data listener and logger system, and a handheld device which may be individually or in combination employed in the system of FIG. 1, in whole or part, according to certain embodiments of the invention;

FIG. 14A illustrates an embodiment of a portable control panel, such as that of FIG. 13, according to certain embodiments of the invention;

FIG. 14B illustrates an embodiment of components of a portable control panel, such as that of FIG. 14A, according to certain embodiments of the invention;

FIG. 15 illustrates an embodiment of a data listener and logger system, such as that of FIG. 13, according to certain embodiments of the invention;

FIG. 16A illustrates an embodiment of a portable handheld device, such as that of FIG. 13, according to certain embodiments of the invention;

FIG. 16B illustrates an embodiment of a room status system of a device, such as the portable handheld device of FIG. 16A, according to certain embodiments of the invention; and

FIG. 17 illustrates an alternative embodiment of a room status system of a cellular telephone, such as an i-Phone™ or other smart phone device, according to certain embodiments of the invention.

### DETAILED DESCRIPTION

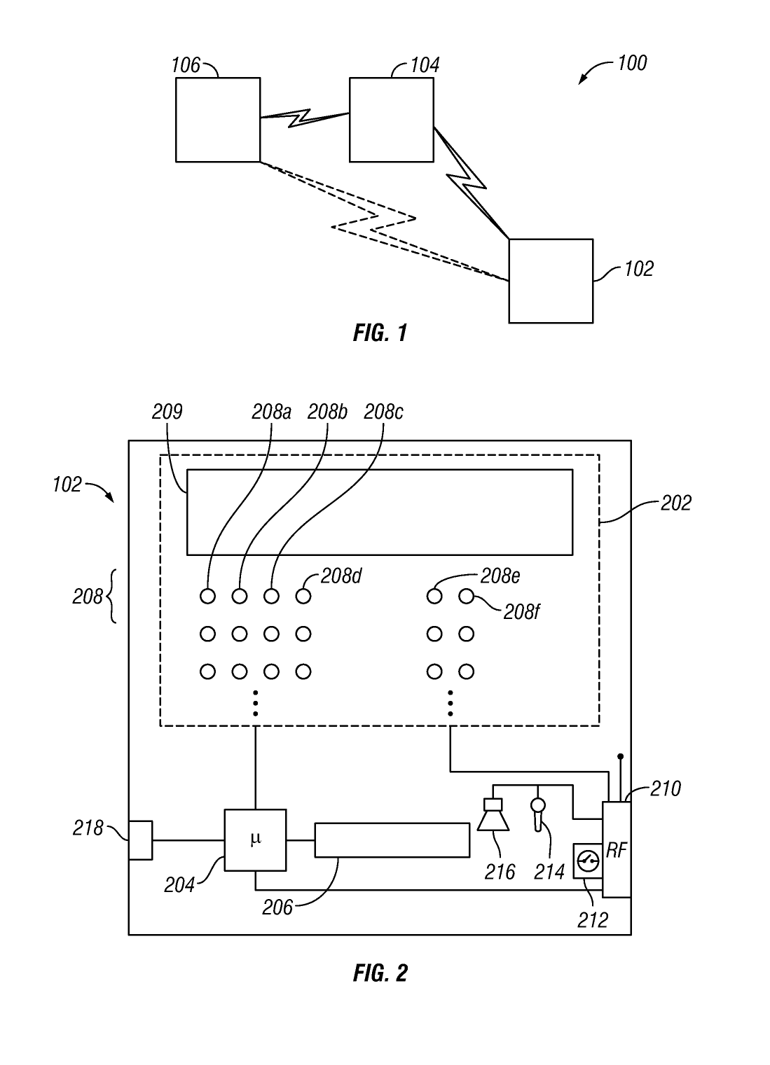

Referring to FIG. 1, a system 100 for notification and advertising includes a control center device 102, an inner panel device 104, and an outer panel device 106. The inner panel device 104 is communicatively connected to the control center device 102. The outer panel device 106 is communicatively connected to the inner panel device 104.

Referring to FIG. 2, the control center device 102 of FIG. 1 is, for example, an electronic, processor controlled device including an input/output interface 202. The interface 202 is connected to a processor 204 and a memory 206. The interface 202 includes a plurality 208 of series of four lights 208a-d and two tactile buttons 208e-f per each series, each two tactile buttons 208e,f corresponding to a particular one of the series of four lights 208a-d. Each light 208a,b,c,d of the series is, for example, a light emitting diode (LED), liquid crystal diode (LCD), filament bulb, or other visual color emitter. Each tactile button 208e,f is, for example, an illuminable pressable switch, such as a button coupled with a light emitting diode (LED) to emit a visual color signal. One tactile button 208a of each series is Red when lighted, and the other tactile button 208b of each series is Green when lighted. Each tactile button 208e,f has four states of visual signal—Off, Steady On, Slow Flashing On, and Fast Flashing On. Each of the four lights 208a,b,c,d emits a different color, corresponding to the state of the tactile buttons 208e,f corresponding to the particular series of the lights 208a-d, as follows: light 208a is red when lit, light 208b is green when lit, light 208c is blue when lit, and light 208d is yellow when lit. The processor 204 controls the state of the lights 208a-d, together with the tactile buttons 208e-f, in correspondence with states of the inner panel device 104, as will be discussed.

In addition, the interface 202 includes a video display 209 connected to the processor 204 and memory 206, such as an outwardly visible LED, liquid crystal diode (LCD), cathode ray tube (CRT), gas plasma, or other multimedia image projection screen. The interface 202 further includes a microphone 214 and a speaker 216 for input and output of voice signals.

The control center device 102 also includes a wireless radio frequency (RF) transceiver 210 connected to the buttons 208 and the processor 204. Alternately, the transceiver 210 is a wired connection (not shown in FIG. 2), or if wireless, a low to mid-Hz radio, Bluetooth™, local area wireless (such as 802.11 compatible), cellular, or other wireless transmit and receive connection to the inner panel device 104. The processor 204, in conjunction with the memory 206, of the control center device 102 connects to and controls the transceiver 210 when communicating, in correspondence to state of the buttons 208 (e.g., as either activated or not). The control center device 102 further includes at least one dual in-line package (DIP) switch 212 connected to the transceiver 210. The DIP switch 212 sets a transmission-reception parameter of the transceiver 210, such as a device identifier to enable communication by the control center device 102 with the inner panel device 104 (shown in FIG. 1). The microphone 214 and the speaker 216 are each connected to the transceiver 210. The control center device 102 includes or connects to a power source (not shown in FIG. 2), such as an AC or DC power supply, for powering of the processor, memory, lights, buttons, microphone, speaker, and display.

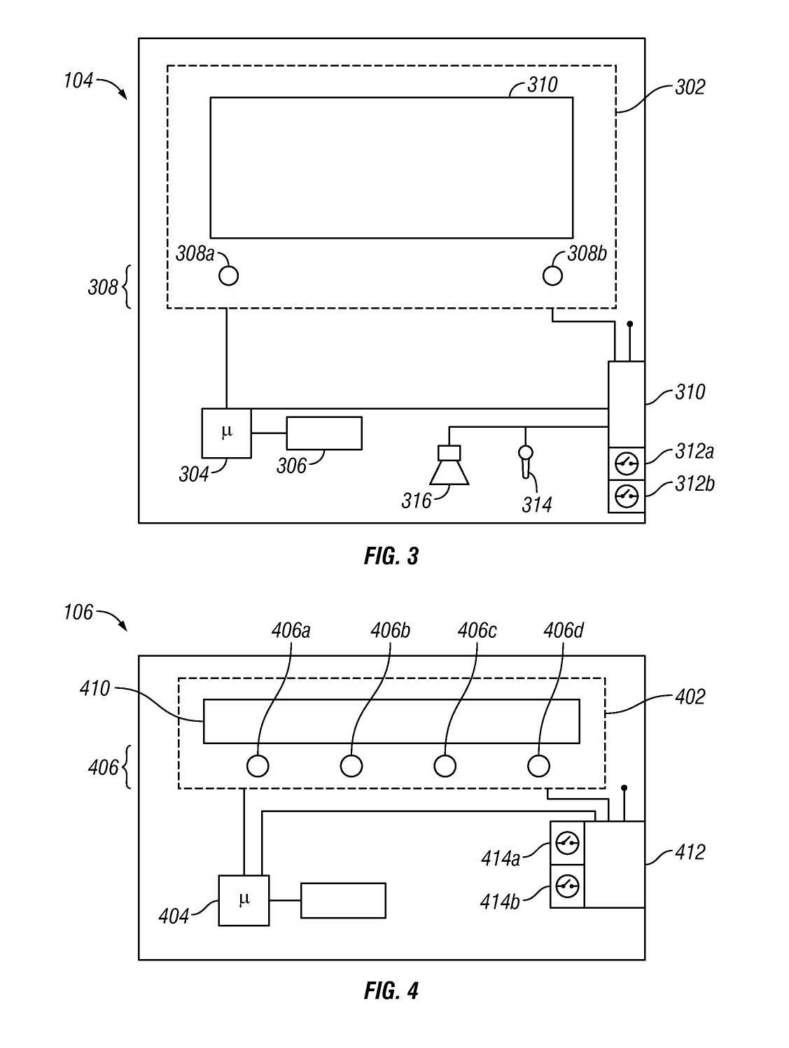

Referring to FIG. 3, the inner panel (IP) device 104 of FIG. 1 is, for example, an electronic, circuit controlled device including an input/output IP interface 302. The IP device 104 includes a circuit 304, such as a microprocessor, and memory 306, connected to the IP interface 302. The IP interface 302 includes two tactile buttons 308, for example, each an illuminable pressable switch to emit a visual color signal, connected to the circuit 304. The buttons 308 are, respectively, a button coupled with a red light emitting diode (IP Red LED) 308a and a button coupled with a green LED (IP Green LED) 308b. Each tactile button 308a,b has four states of visual signal—Off, Steady On, Slow Flashing On, and Fast Flashing On. In addition, the IP interface 302 includes a video display 310 connected to the circuit 304 and memory 306, such as an outwardly visible LED, liquid crystal diode (LCD), cathode ray tube (CRT), gas plasma, or other multimedia image projection screen. Additionally, the IP interface 302 includes a microphone 314 and a speaker 316 for input and output, respectively, of voice signals.

The IP device 104 also includes a wireless RF transceiver 310 connected to the circuit 304, and communicatively connected to the control center device 102 (shown in FIG. 1) and the outer panel device 106 (shown in FIG. 1), respectively. Alternately, the transceiver 310 is a wired connection (not shown), or if wireless, a low to mid-Hz radio, Bluetooth™, local area wireless (such as 802.11 compatible), cellular, or other wireless transmit and receive connection, to the control center device 102 and outer panel device 106, respectively. The IP device 104 includes two DIP switches 312a,b connected to the transceiver 310. One DIP switch 312a sets the RF transceiver 310 of the IP device 104 to communicate with the RF transceiver 210 of the control center device 102. The other DIP switch 312b sets the RF transceiver 310 to communicate with the outer panel device 106 (shown in FIG. 1). The DIP switches 312a,b are a device identifier for the IP device 104 to enable communication with the control center device 102 and the outer panel device 106, respectively. The microphone 314 and the speaker 316 are connected to the transceiver 310. The IP device 104 includes or connects to a power source (not shown in FIG. 3), such as an AC or DC power supply, for powering of the circuit, memory, lights, display, speaker and microphone.

Referring to FIG. 4, the outer panel (OP) device 106 of FIG. 1 is, for example, an electronic, circuit controlled device including an input/output OP interface 402. The OP device 106 includes a circuit 404, such as a microprocessor, connected to the OP interface 402. The OP interface 402 includes four tactile buttons 406, for example, each an illuminable pressable switch to emit a visual color signal, connected to the circuit 404. The buttons 406 are, respectively, a button coupled with a red light emitting diode (OP Red LED) 406a, a button coupled with a green LED (OP Green LED) 406b, a button coupled with a blue LED (OP Blue LED) 406c, and a button coupled with a yellow LED (OP Yellow LED) 406d. Each tactile button 406a,b,c,d has four states of visual signal—Off, Steady On, Slow Flashing On, and Fast Flashing On. In addition to the OP interface 402, the OP device 104 includes a static display 410, such as an outwardly visible legend or other picture or display.

The OP device 106 also includes a wireless RF transceiver 412 connected to the circuit 404, and communicatively connected to the IP device 104 (shown in FIG. 1). Alternately, the transceiver 412 is a wired connection (not shown), or if wireless, a low to mid-Hz radio, Bluetooth™, local area wireless (such as 802.11 compatible), cellular, or other wireless transmit and receive connection, to the IP device 106. The OP device 106 includes two DIP switches 414a,b connected to the transceiver 412. One DIP switch 414a sets the RF transceiver 412 of the OP device 106 to communicate with the RF transceiver 310 of the IP device 104. The other DIP switch 414b identifies the OP device 106 for the control center device 102, as corresponding to the IP device 104 for purposes of operations. The OP device 106 communicates with the IP device 104, and the IP device 104 communicates with the control center device 102 to register the OP device 106 as so corresponding to the IP device 104 because of the setting of the DIP switch 412b. The OP device 106 includes or connects to a power source (not shown in FIG. 4), preferably a DC power source, such as a battery, internally contained in the OP device 106.

In alternatives, the IP device 104 of the system 100 includes an accessible connector 218 (shown in FIG. 3), such as, for example, a Universal Serial Bus (USB) port, mini-USB port, serial port, or other port interface to the IP device 104. The connector 218 permits a USB plug or other compatible plug connection to the IP device 104, for example, to upload or download data and information to the IP device 104 or other service. In other embodiments, upload, download and other service is wirelessly controlled via communications of the control center device 102 with the IP device 104. In certain embodiments, a servicer of the system 100 provides periodic replacement of battery and change of content and programming. Firmware or other software or hardware programming of the system 100 is performed via the IP device 104 through a second connection thereto, such as a mini-USB port accessible to the programmer. Alternately, such programming is by connection to the control center device 102 and/or OP device, directly via connector or via wireless communication.

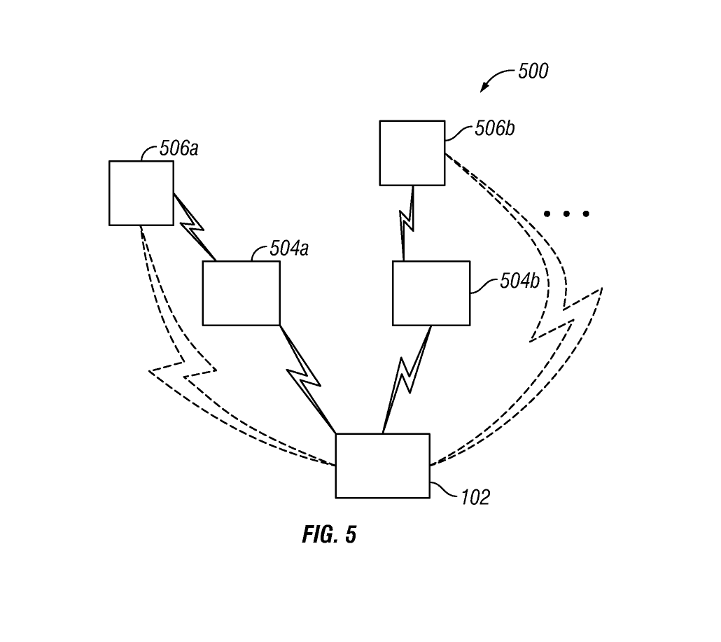

Referring to FIG. 5, a system 500, comprises the control center device 102 and a plurality of IP devices paired with corresponding OP devices, for example, paired devices (IP device 504a, OP device 506a) and (IP device 504b, OP device 506b), etc. The respective IP device 504a and IP device 504b of the paired devices comprises a distinct one of the IP device 104 of FIG. 1. Each respective OP device 506a and OP device 506b of the paired devices comprises a distinct one of the OP device 106 of FIG. 1. The respective paired devices, i.e., pair IP device 504a, OP device 506a and pair IP device 506a, OP device 506b, are sometimes collectively referred to as the “paired device (a)” and the “paired device (b)”, respectively, for purposes of reference herein. The IP device of each respective paired device of the system 500 communicates with control center device 102. Each respective IP device also communicates with its corresponding OP device of the pair. Each respective OP device communicates with its corresponding IP device, and the IP device in each instance communicates state of the OP device with the control center device 102.

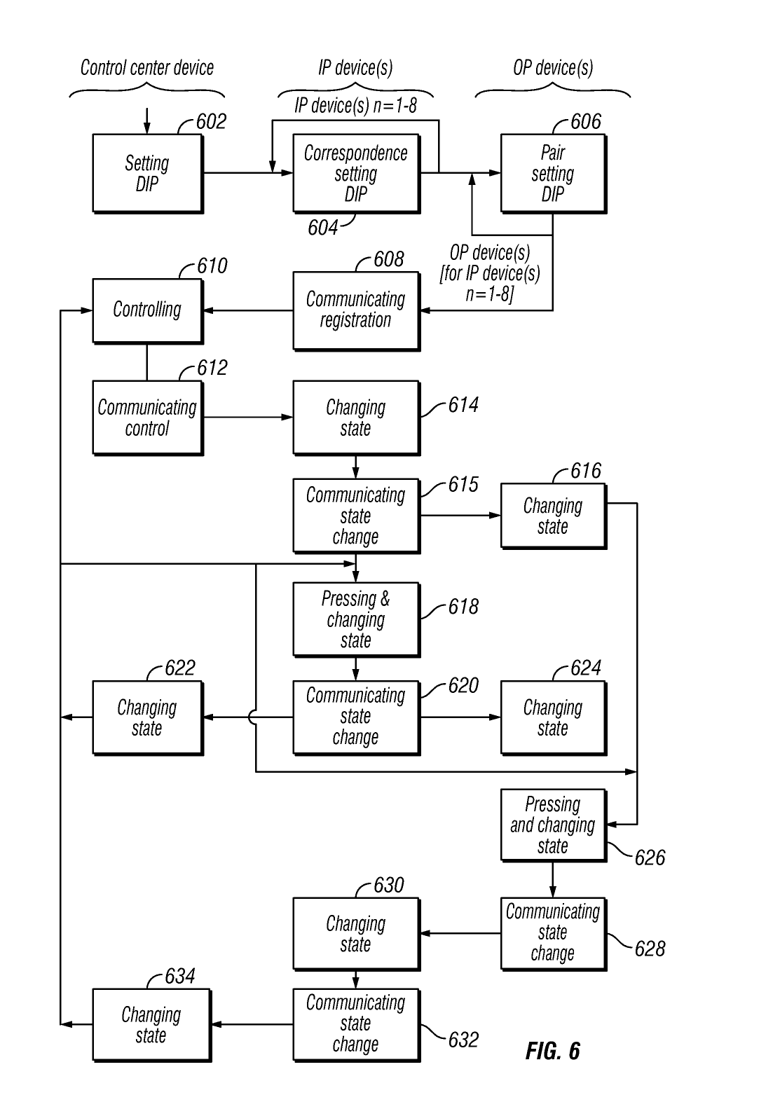

Referring to FIG. 6, in operation, the systems 100,500 perform a method 600. In a setting step 602, the DIP switch 312a of each IP device 104 of the system is set to correspond with setting of the DIP switch 212 of the control center device 102. A single control center device 102 operates for a plurality of the paired devices. In certain embodiments, the paired devices of the system 100,500 may number from one to the maximum numbers of the plurality 208 of series of four lights 208a-d and two tactile buttons 208e-f available in the control center device 102.

In a correspondence setting step 604, the DIP switch 312b of each IP device 104 is set to correspond with setting of the DIP switch 414b of the corresponding OP device 106. In a pairing step 606, the DIP switch 414a of each OP device 106 is set to identify the OP device 106 as paired with the respective IP device 104 for purposes of identification by the control center device 102.

The IP device 104 communicates with the control center device 102 in a step 608. Each respective IP device 104, and thereby each respective paired OP device 106, performs the step 608 to register with the control center device 102. Upon registration of the IP device 104 with the control center device 102, a step of controlling 610 by the control center device 102 occurs for one of the plurality 208 of series of lights 208a-d and buttons 208e-f per series. The one of the plurality 208 corresponds to state of the IP device 104 and OP device 106, and provides indication of that state at the control center device 102 via the on or off lights 208a-d.

In a step 610, one of the buttons 208e-f for the one of the plurality 208 is pressed to control the state of the lights 208a-d at the control center device 102 and to communicate that state to the IP device 104. On communication of such state by the control center device 102 in a step 612, the IP device 104 changes its lighted state (as hereafter further detailed), if required based on the button command communicated from the control center device 102.

In a step 614, a change to lighted state of the IP device 104 occurs on receipt of communication from step 612. In as step 615, the IP device 104 communicates the state change to the OP device 106. In a step 616 OP device 106 receives the communication and changes its lighted state (as hereafter further detailed), if required based on the communication from the IP device 104.

Conversely, when one of the buttons 308 of the IP device 104 is pressed in a step 618, the state of the lighted button 308 of the IP device 104 changes, if required. By pressing the button 308 in the step 614, the IP device 104 commences communicating in a step 620 with the OP device 106 and the control center device 102. Upon receipt of the communication from the step 620 at the control center device 102, the control center device 102 is controlled in a step 622 to change state of the plurality 208 of series of lights 208a-d corresponding to the particular IP device 104 (as hereafter further detailed), if required. The communication in the step 620 between the IP device 104 and the OP device 106 also controls the OP device 106 in a step 624 to change lighted state of the OP device 106 (as hereafter further detailed), if required.

Similarly, when one of the buttons 406 of the OP device 106 is pressed in a step 626, the OP device 106 communicates to the IP device 104, in a step 628. On receiving the communication, the IP device 104 in a step 630 controls its lighted state to conform to the action at the OP device 106, as necessary. The IP device 104 further, in a step 632, communicates with the control center device 102 this change in lighted state and the control center device 628 changes its lighted state to conform in a step 628.

In effect change of state at any of the IP device 104, the OP device 106 or the control center device 102, by pressing the respective buttons, is communicated and state is changed for each other of these devices, such that states of the devices correspond according to desired pattern and protocol per system programming and configuration. Wide variety of such programming and configuration, as well as wide variation in pattern and protocol of corresponding state change among devices, is possible in accordance with desired operations of the systems and methods. Additional data may also be communicated by the control center device 102 to the IP device 104. For example, the display 310 of the IP device 104 can project video images of advertisements or other content. Files for the images can be stored in the memory 306 and played on the display 310 in random, sequenced, programmed or other sequence. In certain embodiments, for example, video displays can be controlled by state of the buttons 308; state of the lights 208a-d and buttons 208e-f at the control center device 102; and/or state of the buttons 406 of the OP device 106. Additionally, video displays of the IP device 104 can be varied according to occurrences at the control center device 102, such as via input of additional or different files to the control center device 102 and consequent communication by the control center device 102 to the IP device 104 at periodic intervals, on the fly, in real time, or according to other protocol or schedule.

In certain specific embodiments of the systems 100,500 and the method 600, operations are as follows:

A control center device is located at a central location of an office, for example, at a reception desk. A respective IP device is located in each of several rooms of the office on a desk, table, or on a wall, such as in each of several patient examination room in a physician's office or otherwise. A respective OP device for pairing to each separate IP device is located adjacent to, but outside the room of the office in which the paired IP device is located, such as on a wall near an entry door to the room of the IP device.

The DIP switch of the control center device and one of the DIP switches of each IP device is set to correspond, so that the IP devices each communicate with the control center device from respective rooms. A DIP switch of each OP device is set to correspond for proper identification by the control center device. A second DIP switch of each IP device is set to correspond to its paired OP device adjacent but outside the room of the IP device. A second DIP switch of the OP device is set to correspond to the paired IP device.

The control center device has separate sets of four colored lights (Red, Green, Blue and Yellow) and two illuminable colored buttons (Red and Green) for each IP device and OP device pair in use. For example, the control center device includes eight sets of the four lights/two buttons. The control center device also has a visual media or static display and audible microphone/speaker input and output.

Each of the IP devices has two illuminable buttons (Red and Green). Each IP device also has a video display, a microphone, and a speaker. Each OP device, paired to an IP device, has four illuminated colored buttons (Red, Green, Blue and Yellow). Each OP device wirelessly communicates with its paired IP device, and all IP devices wireless communicate with the control center device.

Each set of four lights and two buttons of the control center device corresponds to a unique pair of the OP device and the IP device, and the four lights correspond to state of the OP device and the two buttons correspond to state of the IP device of the pair. Because of the two buttons of the control center device for a particular IP device and the two buttons of the corresponding IP device, change in state of the two lights of the control center device for the IP device can be made by pressing one of the buttons of the IP device; and, conversely, pressing one of the two buttons of the control center device for the particular IP device, changes state of the two lights of the IP device. The same applies for each set of two buttons of the control center device as to the corresponding IP device. Each OP device paired to an IP device has four buttons, corresponding to one set of four lights of the control center device for the OP device (i.e., for the particular OP device and IP device pair). State of the OP device is reflected on the lights at the control center device, because of communications of the OP device with its paired IP device and the ensuing communication of the IP device with the control center device. Pressing one of the four buttons of the OP device changes state of the four lights of the control center device for that OP device.

In the specific embodiment, any number of the four buttons of the OP device can be triggered on and illuminated at any point. Corresponding lights for the OP device at the control center device are “on” consistent with the buttons of the OP device. Buttons of the paired IP device for the OP device also can be triggered on, one at a time (i.e., either Red on or Green on, but not both on or both off). Corresponding buttons for the IP device at the control center device are “on” or “off” consistent with the buttons of the IP device. Because the buttons of the control center device for a particular IP device also can be pressed triggering communication by the control center device to the IP device, the state of the buttons of the IP device can thereby be controlled also by the control center device.

The microphone and speaker of the control center panel, and the microphone and speaker of each IP device, can be switched on or off at any time either at the control center panel or at the IP device, respectively. The IP device can initiate voice calls to the control center panel at any time, by switch on of the microphone and speaker. The microphone and speaker of the control center panel are active on at all times. The IP device receives calls made from the control center panel only if state of the IP device is then in “call allowed status”.

The four buttons of the OP device paired with the IP device are employed as follows in certain operations. When the room is unoccupied, the green button of either the OP device or the IP device is pressed to turn on illumination. Once the room becomes occupied and privacy is desired, the red button of either the OP device or the IP device is pressed to turn on illumination and the green button turns off. For example, when a doctor enters the room to examine a patient in the room, the doctor presses the red button of the IP device to on to illuminate the red button of the IP device. The IP device communicates this state of red button on to the paired OP device and the control center device. The OP device illuminates the red button and turns off the green button. The control center device illuminates the red light for the particular IP device. The red state can also be controlled at the OP device by pressing the red button for on, or the green button for off, at the OP device.

The blue and yellow buttons of the OP device provide flags for additional functions of the IP device, such as for enabling/disabling calls to the IP device by the control center device and for video display operation of the IP device. For example, once a patient has entered the room but before the doctor arrives at the room, the blue button may be pressed to on. This initiates the video display operation of the IP device. The display of the IP device then shows video according to files of the IP device stored in memory or, alternately, as dictated by the control center device through programming there. The yellow button, when pressed to turn on, blocks calls by the control center device to the IP device, such as once the doctor enters the room and privacy is desired with the patient.

Because each button provides four states of visual signal—Off, Steady On, Slow Flashing On, and Fast Flashing On—various alternatives are possible. In an exemplary embodiment of a busy clinic with four doctors seeing patients, one doctor, Dr. Jones, is assigned the Red button. When a patient is escorted into a room, the nurse presses the Red button of the OP device turns steady on, and the Red light for the OP device/IP device pair turns on at the control center device. The Red light on the IP device turns to fast flashing on, to draw attention to it. While waiting for Dr. Jones, the display of the IP device plays video, such as advertisements or other content. Once Dr. Jones passes the room prior to entry, the doctor views the OP device and sees a steady on Red light indicating that a patient is waiting in the room. When Dr. Jones goes into that room, the Red light of the IP device which is fast flashing on draws the doctor's attention and he presses the Red button again and it turns to slow flashing on. A next press on the Red button turns off the Red button and it is converted to a call button for the doctor to call the control center panel and communicate with the control center device via the microphone and speaker of the IP device. On completion of the examination and when leaving the room, the Red button is again pressed to turn off the Red button to indicate at the control center device via the applicable Red light and the OP device via its Red button that the examination is complete.

Other buttons of the IP device, the OP device, and the respective lights and buttons of the control center device provide a variety of possible functions similar to the foregoing. The systems are programmable to operate as desired for the particular office and room situation and needs. In certain arrangements, the IP device can serve two primary functions. One function, via the call feature to the control center device, allows the doctor or other user to press an applicable button to ask for assistance or make request. Another function, via other button, allows the control center device to register a lighted notification at the IP device, such as a need at the reception desk or a visitor. These can be indicated at the IP device by different flash character of illumination of the button or buttons of the IP device, as triggered by pressing the button(s) of the control center device. Further, blocking and allowance of communications from the microphone and speaker of the control center device to and with the microphone and speaker of the IP device can be controlled at the IP device buttons or otherwise. Of course, numerous variations are possible in indicators and meanings which are possible by and for the buttons, lights, and features of each of the IP device, the OP device and the control center device.

Video content played on the display of the IP device, content of the static display at the OP device, and other features allow various advertising of commercial products, services, public service or health announcements, and other information. In certain embodiments, systems according to the foregoing are made available to doctors in return for allowing advertising display on the IP device, the OP device and the control center device.

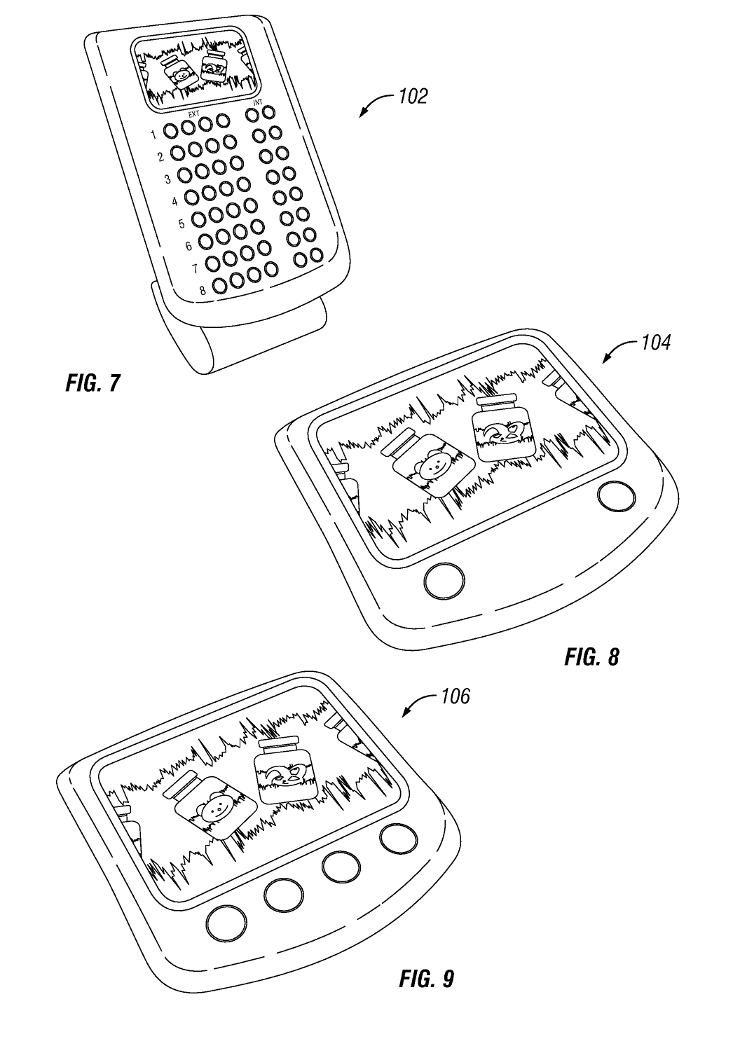

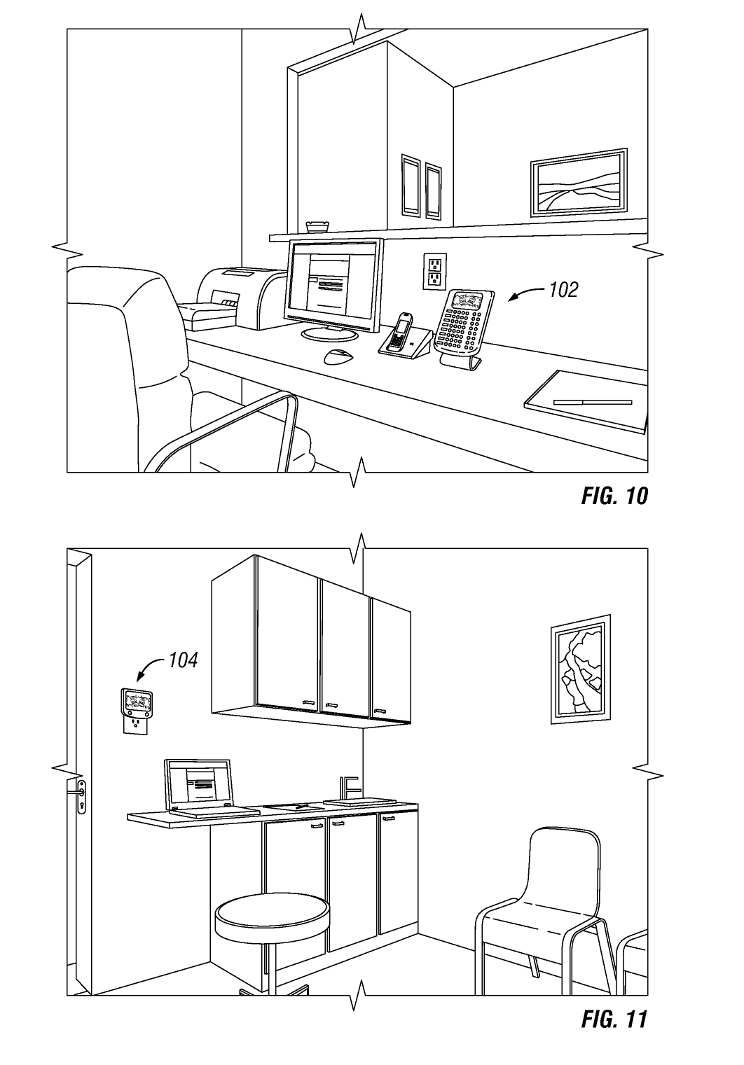

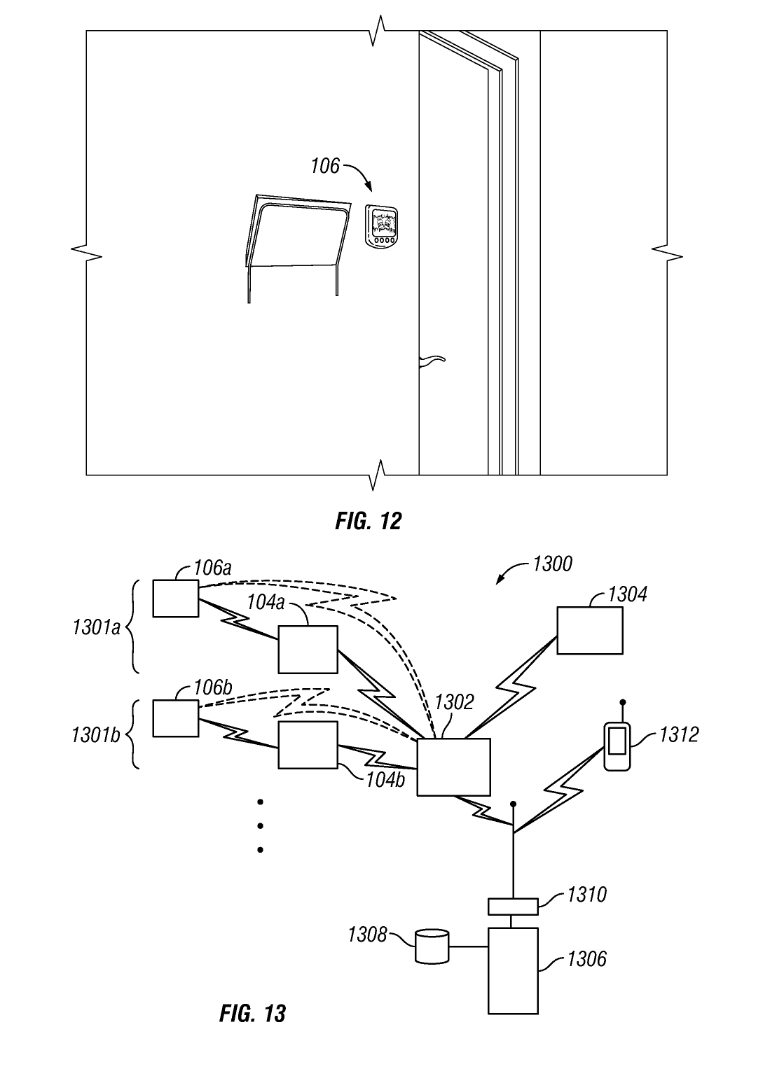

Further exemplary embodiments of the systems and methods are shown in FIGS. 7-12.

Referring to FIG. 13, a system 1300 for notifying of a status includes at least one matched set 1301a of an inner panel device 104a and an outer panel device 106a. The inner panel device 104a is communicatively connected to a control center device 1302. The outer panel device 106a is communicatively connected to the inner panel device 104a. The system 1300 may include additional matched sets 1301b, as well as others, in alternative embodiments.

The system 1300 also comprises one or more of a portable control panel 1304, a data listener and logger system 1310, and a handheld device 1312. The system 1300 can also include a computer 1306 communicatively connected to the data listener and logger system 1310, if present. If present in the system 1300, the portable control panel 1304 is communicatively connected to the control center device 1302, the handheld device 1312 is communicatively connected to the data listener and logger system 1310, and/or the data listener and logger system 1310 is communicatively connected to the control panel device 1302 and the computer 1306. The computer 1306, if present in the system 1300, includes or is communicatively connected to a data storage 1308.

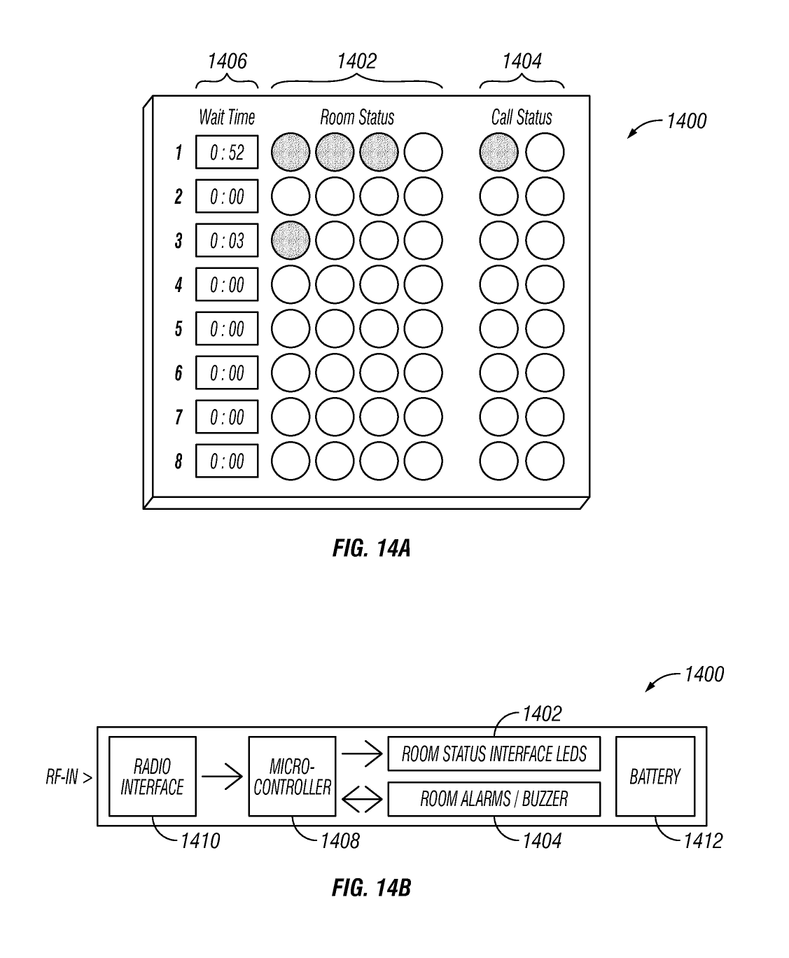

Referring to FIG. 14A, in conjunction with FIG. 13, a portable control panel 1400, according to the foregoing, includes a plurality of series of four lights 1402. Each of the series of four lights 1402, for example, corresponds to room status indicated at the control center device 1302 for a unique matched set, for example, matched set 1301a or 1301b.

In certain alternatives, the portable control panel 1400 includes a plurality of series of two lights 1404. Each of the series of two lights 1404, for example, corresponds to call status indicated at the control center device 1302 for a unique matched set, for example, matched set 1301a or 1301b.

In certain other alternatives, the portable control panel 1400 includes a unique wait time display 1406 for each series of four lights 1402. The wait time display 1406, for example, is communicated by the control center device 1302 to the portable control panel 1400. As an example, determination of wait time is calculated by or in conjunction with operations of the control center device 1302, such as by processing at the control center device 1302 via software stored in memory, via input to the control center device 1302 by external source, or through other operation of or in conjunction with the system 1300.

Referring to FIG. 14B, in conjunction with FIGS. 13 and 14A, the portable control panel 1400 includes a microcontroller 1408, a radio interface 1410 connected to the microcontroller 1408, the plurality of series of four lights 1402 connected to the microcontroller 1408, and a power supply 1412 connected to the microcontroller 1408, radio interface 1410, and the plurality of series of four lights 1402. In alternatives, the portable control panel 1400 includes the plurality of series of two lights 1404 and/or, in alternatives, includes alarms, buzzers or other notifiers corresponding to status for rooms. The portable control panel 1400, in certain alternatives, includes a switch or other mechanism (not shown in FIG. 14B) for pairing the portable control panel 1400 with an applicable control center device 1302 for communications therebetween.

In operation, the portable control panel 1400 communicates via the radio interface 1410 with the control center device 1302 (or alternatively, another device of the system 1300, such as the data listener and logger system 1310). Based on the communication, the microcontroller 1408 controls the respective series of four lights 1402 and respective series of two lights 1402 to illuminate in correspondence with the then-current state of the matched sets 1301a,b (i.e., for respective rooms) indicated at the control center device 1302. The microcontroller 1408 and radio interface 1410 are operationally powered by the power supply 1412, for example, a battery. In alternatives including the plurality of series of two lights 1404 and/or other alarms, buzzers and features, the microcontroller 1408 controls illumination and/or other operation of these powered by the power supply 1412. In further alternatives, the plurality of series of two lights 1404 can be buttons or other mechanism of the portable control panel 1400 allowing the portable control panel 1400 to direct input to the control center device 1302, for example, to change states of lights or other operations of the control center device 1302. In such alternatives, all panels and devices of the system 1300 are communicatively synced for display and operational characteristics of the respective elements.

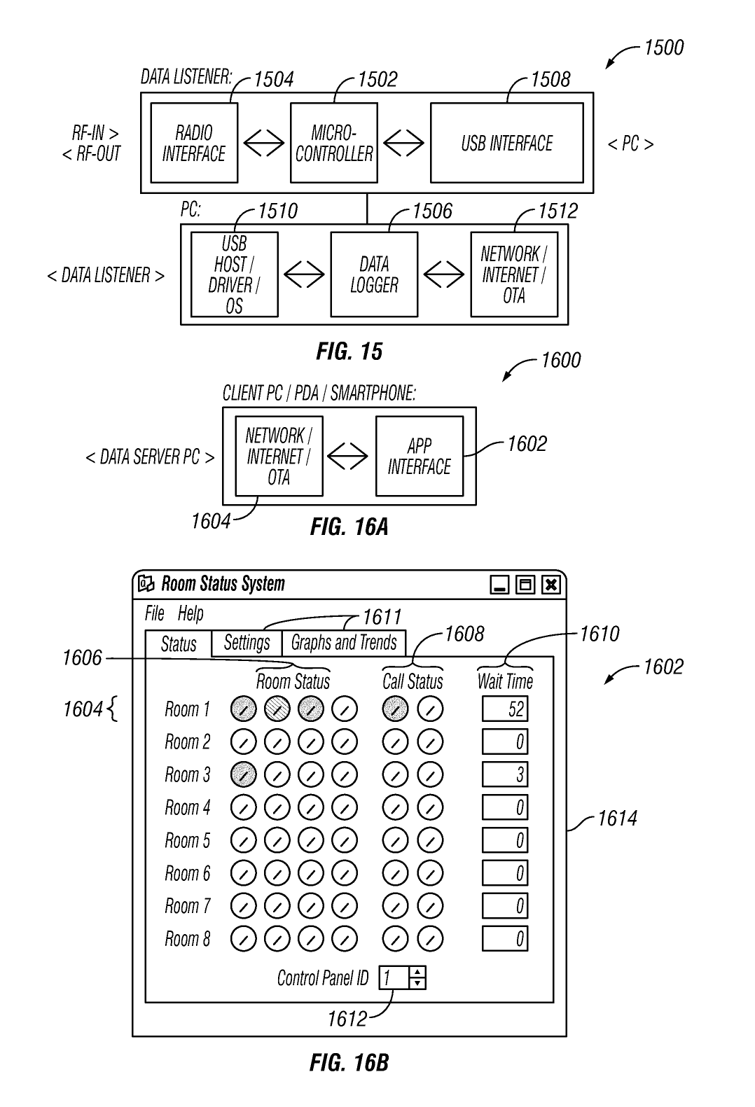

Referring to FIG. 15, in conjunction with FIG. 13, a data detector and logger 1500, for example, the data listener and logger system 1310 and the computer 1306 (where these are present in the embodiment) of the system 1300, includes a microcontroller 1502, a radio interface 1504 connected to the microcontroller 1502, and a power source (not shown in FIG. 15) connected to the microcontroller 1502 and the radio interface 1504. The data detector and logger 1500 also includes a data logger 1506 connected to the microcontroller 1502 and the power source. In certain alternatives, such as in the case of the data listener and logger system 1310 and the computer 1306 as the data detector and logger 1500, the data listener and logger system 1310 includes the microcontroller 1502, the radio interface 1504 and a connector 1508. The connector 1508 is connected to the microcontroller 1502 and communicatively connects the data listener and logger system 1310 to the computer 1306. In the alternatives, the computer 1306 includes a mating connector 1510 for connection to the connector 1508. The computer 1306 also includes the data logger 1506. The data logger 1506 is, for example, a database stored in memory, such as a database of the computer 1306 connected to or incorporating the data storage 1308. The database of the computer 1306 maintains data obtained by the data listener and logger system 1310, of states, communicated information, and other data of the system 1300. In other alternatives, the computer 1306 communicatively connects to a communication network (not shown), such as, for example, the Internet, cellular data network, local or wide area network, or other network (e.g., TCP/IP, Ethernet, WiFi, EVDO, EDGE, 3G/4G, SMS, or other network or communication channel, and/or combinations.

In operation, the data detector and logger 1500 by the radio interface 1504 detects signals communicated between devices of the system 1300, either via direct or indirect communicative connection with respective devices. On detection of signals, the microcontroller 1502 controls the data logger 1506 to store the signals or information in respect of the signals. In alternatives in which the data listener and logger system 1310 and the computer 1306 is the data detector and logger 1500, the microcontroller 1502 controls the connector 1508 to communicate the signals or information to the mating connector 1510 of the computer 1306. The data logger 1506 of the computer 1306 stores and maintains the signals or information in respect of the signals, such as in a database stored in memory of the computer 1306.

In certain alternatives, the computer 1306 selectively communicates the signals or information in respect of the signals to the handheld device 1312. In other alternatives, the signals or information are communicated to the handheld device 1312 by the data listener and logger system 1310.

Referring to FIG. 16A, in conjunction with FIG. 13, a portable device 1600, for example, the handheld device 1312 of the system 1300, communicatively connects to the data detector and logger 1500, either directly or indirectly. The portable device 1600 includes a processor, memory connected to the processor, and a display connected to the processor (not shown in FIG. 16a). The portable device 1600 also includes a room status system 1602, for example, a program stored in memory of the portable device 1600 or communicatively accessible to the portable device 1600, and a radio interface 1604 connected to the processor. The room status system 1602 is operated and controlled by the processor, and is responsive to communications of the portable device 1600 via the radio interface 1604.

Referring to FIG. 16B, in conjunction with FIGS. 13 and 16A, the room status system 1602 displays on the portable device 1600 an interactive graphic structure 1614. The graphic structure 1614 includes a series of indicators 1604 for each of one or more rooms corresponding to the matched sets of the system 1300, for example, eight series of indicators 1604 in the illustrated embodiment. Each series of indicators 1604 comprises a series of four room status indicators and a series of two call status indicators. In alternatives, each series of indicators 1604 comprises a wait time LED display 1610. In certain alternatives, the interactive graphic structure 1614 includes additional tabs 1611, such as for settings and graphs/trends, which display various informational details about operations of the system 1300 and devices of the system 1300. In other alternatives, the graphic structure 1614 includes a control panel identifier 1612.

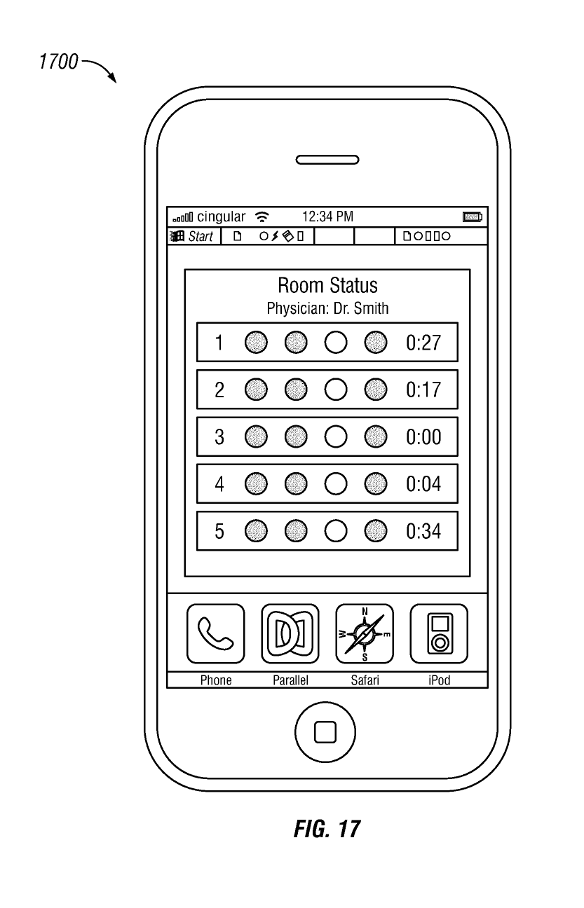

Referring to FIG. 17, an alternate embodiment of a handheld device, for example, similar to the portable device 1600 of FIGS. 16A-B, is a cellular smartphone 1700, for example, an iPhone™ or Windows Mobile™, Android™ or other communications device with processing and application capabilities. The smartphone 1700 includes an output interface, for example, a display visible to a user, and a cellular and/or wireless radio for communicating in the embodiments of systems and methods according to the foregoing. In certain embodiments, the smartphone 1700 includes additional features, for example, an input interface for interacting with the systems and methods of embodiments; a timekeeper; a processor; software stored in memory of the smartphone 1700 or otherwise accessible to the smartphone 1700, such as for logical operations at the smartphone 1700 and communicative interactivity with and in the systems and methods of embodiments, and other interactive and smartphone-capable applications and related elements.

In operation, the room status system 1602 displays on the handheld device 1312 the graphic structure 1614 in response to and in form corresponding to information communicated between the handheld device 1312 and the data detector and logger 1500 (or other aspect of the system 1300, if applicable). Through such communicated information, the appearance of the series of indicators 1604 corresponds in the graphic structure 1614 to state of the system 1300 as then logged and/or existing at devices in the system 1300. The wait time LED display 1610 operates to provide an applicable wait time expected for each series, such as for each room and respective device(s) according to the system 1300. The control panel identifier 1612 operates to indicate a control center device or other device of the system 1300 to which the graphic structure then corresponds. In alternatives, other tabs of the graphic structure provide additional information regarding the system 1300 and display reports indicative of the information, and provide for input to change form or characteristics of display and operations of the room status system 1602 on the handheld device 1312.

In the foregoing embodiments, the systems and aspects, elements and features thereof may be varied, changed, modified, and altered, including by additions, substitutions and deletions of such aspects, elements and features and operations. For example, devices of the system may include chimes, tones, or other audible, visual or tactile outputs, to alert users. Audible intercom capabilities of the respective devices may be varied or additionally provided in the devices or external devices or systems in connection with the systems and devices. In other examples, the systems and devices can be programmed to yield additional functions, features, and operations, including such as auto discovery or manual discovery of devices, states, settings and the like. The system and/or respective devices can include additional or other connectivity, ports, adapters, and resources, for example, firmware, software, hardware, logic and storage capabilities and elements may be changed, controlled, updated, fixed, and otherwise maintained via USB or other digital media port and change to one device can be automatically, manually or otherwise alter, bear on, or affect change to the systems and other devices thereof. In other examples, video content, in particular, may be loaded into each interior panel via the USB or other digital media port or wirelessly from the control panel. The control panel then receives its content by either a local download or via a network connection which would allow content to be loaded remotely. In addition to these alternatives and examples, numerous other variations are possible all in keeping with the scope of the foregoing.

What is claimed is:

1. A system for use in multi-rooms of an office space or other multi-room facility, comprising:
a central control device;
an inner panel device wirelessly communicatively connected to the central control device; and
an outer panel device wirelessly communicatively connected to the inner panel device and/or the control device
wherein the control center device includes illuminated notifiers and control center buttons, the illuminated notifiers identify a state of each of the inner panel device and the outer panel device, as communicated between the inner panel device and the control center device, and the control center buttons, when selectively activated, change a state of the inner panel device;
wherein the inner panel device includes a video display and inner panel buttons, the inner panel buttons flag and show a state of the inner panel device, according to states of the outer panel device and the control center device, as communicated between the inner panel device and the control center device and as communicated between the outer panel device and the inner panel device;
wherein the outer panel device includes a static display and outer panel buttons, the outer panel buttons flag and show a state of the inner panel device, according to states of the inner panel device, as communicated between the inner panel device and the outer panel device;
wherein change of state at the outer panel device, via selective activation of an outer panel button, is communicated to the inner panel device and on to the control panel device and states at the inner panel device and the control panel device are changed accordingly;
wherein change of state at the inner panel device, via selective activation of an inner panel button, is communicated to the outer panel device and the to the control panel device and states at the outer panel device and the control panel device are changed accordingly; and
wherein, select activation of a control center button for the inner panel device effects change to state of the inner panel device and the outer panel device.

2. The system of claim 1, further comprising:
the inner panel device includes an audible communication feature; and
and the control center device includes an audible communication feature;
wherein the inner panel device and the control center device selectively exchange audible message communications.

3. The system of claim 1, wherein the video display plays multimedia of an advertisement.
